(19) United States
(12) Patent Application Publication
(10) Pub. No.: US 2007/0112089 A1
(43) Pub. Date: May 17, 2007

(54) Process for the production of polyethylene

(76) Inventors: Heinz Boelt, Wolfratshausen (DE); Peter Matthias Fritz, Unterhaching (DE); Peter Ulbrich, Pullach (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 11/442,596

(22) Filed: May 30, 2006

Related U.S. Application Data
(60) Provisional application No. 60/752,401, filed on Dec. 22, 2005.
(60) Provisional application No. 60/752,398, filed on Dec. 22, 2005.

(30) Foreign Application Priority Data
Nov. 11, 2005 (DE) 102005054287.5

(51) Int. Cl. B05D 3/06

(52) U.S. Cl. 522/2

(57) ABSTRACT

The invention relates to a process for the production of polyethylene with a stage for steam-cracking hydrocarbons to obtain ethylene and a polymerization stage to produce polyethylene, wherein a degassing stream is obtained from the polymerization stage, the degassing stream is used as a feedstock stream for the stage for steam-cracking.

### RELATED APPLICATION

This application claims the benefit under 35 U.S.C. 119(e) of Provisional Application 60/752,401 filed Dec. 22, 2005. Also, this invention may be related to our concurrently filed application entitled “Process For The Production Of Polypropylene” based on Provisional Application 60/752,398 filed Dec. 22, 2005.

SPECIFICATION

This invention relates to a process for the production of polyethylene with a stage for steam-cracking hydrocarbons to obtain a cut comprising ethylene, and a polymerization stage for producing polyethylene wherein a degassing stream is obtained.

Processes for polyethylene production are known in which a hydrocarbon-containing stream is treated in a steam-cracking stage. The resultant ethylene that is produced by steam-cracking is subsequently polymerized in a polymerization unit to form polyethylene. In a conventional polymerization unit, a relatively large degassing stream is obtained in the degassing of the polyethylene product. The latter is usually worked up in the polymerization unit in an expensive processing unit that provides a seal, condensation, ethane/ethylene separation and additional steps. The ethylene that is recovered in this case is used in the polymerization unit again as a feedstock stream. The processing unit that is described for conventional working-up of the degassing stream is expensive to build and therefore gives rise to high investment costs.

### SUMMARY OF THE INVENTION

An object of this invention is to provide an improved process for the production of polyethylene that is simpler and more economical compared to the foregoing systems.

Upon further study of the specification to appended claims, other objects and advantages will become apparent.

To achieve these objects the degassing stream is used as a feedstock stream for the steam-cracking stage. Thus, the degassing stream from the polymerization stage is advantageously returned directly to the steam cracking stage and is worked up there. Accordingly, the expensive processing equipment comprising a compressor, condenser, ethane/ethylene separation, etc., as described above becomes unnecessary. It is appreciated that by passing the degassing stream to the steam cracking stage, the scale of the latter stage may be increased. Nevertheless, the overall investment costs of the entire unit (steam-cracker and polymerization stage) are substantially reduced.

Typically nitrogen is used in the degassing step, which then will be present in the vent gas stream. In the case that the vent gas stream of a polyethylene plant will be routed to a steam cracking plant, the nitrogen ends up in the tail gas fraction. This fraction will be then utilized as fuel gas; therefore, a build-up of nitrogen is avoided. Whereas the recycling of the vent stream to the steam cracking plant increases the load on the separation section of plant, this increase is comparably small and the separation section can easily be scaled up to accommodate same.

According to an advantageous further development of the invention and before feeding as a feedstock stream into the stage of steam-cracking, the degassing stream is passed over an adsorber suitable for removing catalytic poisons, or catalyst residues, and other undesirable substances.

According to another advantageous further development of the invention and before feeding as a feedstock stream into the stage for steam-cracking, the degassing stream is subjected to a scrubbing step suitable for removing catalytic poisons catalyst residues, and other undesirable substances.

Both embodiments have the purpose of removing substances that could limit the stage for steam-cracking in its functionality.

Both the steam cracking of an ethane-containing hydrocarbon stream to produce ethylene and the polymerization of ethylene to produce polyethylene are old processes and are described in the patent and technical literature and are well known to those of ordinary skill in this field. Common to polyethylene processes is a degasification step. Consequently, this invention is applicable all such systems having a degasification step.

The entire disclosures of all applications, patents and publications, cited herein and of corresponding German application No. 102005054287.5, filed Nov. 11, 2005 and provisional application 60/752,401 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. In a process for the production of polyethylene comprising subjecting ethane-containing hydrocarbons to a steam cracking stage to produce ethylene and polymerizing the resultant ethylene in a polymerization stage wherein a degassing stream is obtained, the improvement wherein the degassing stream is passed as a feedstock stream to the steam-cracking stage.

2. A process according to claim 1, wherein before the feeding of the degassing stream as a feedstock stream into the stage for steam-cracking, the degassing stream is passed over an adsorber suitable for removing catalyst poisons, catalyst residues or undesirable other substances.

3. A process according to claim 1, wherein before the feeding of the degassing stream as a feedstock stream into the stage for steam-cracking, the degassing stream is subjected to a scrubbing step suitable for removing catalyst poisons, catalyst residues or other undesirable substances.

4. A process according to claim 2, wherein before the feeding of the degassing stream as a feedstock stream into the stage for steam-cracking, the degassing stream is subjected to a scrubbing step suitable for removing catalyst poisons, catalyst residues or other undesirable substances.

5. A process according to claim 1, comprising venting the polymerization stage with nitrogen, passing the resultant vent gas to the steam cracking stage, and removing from the steam cracking stage a tail gas containing the nitrogen and residual combustibles.

6. A process according to claim 5, wherein before the feeding of the degassing stream as a feedstock stream into the stage for steam-cracking, the degassing stream is passed over an adsorber suitable for removing catalyst poisons, catalyst residues or undesirable other substances.

7. A process according to claim 5, wherein before the feeding of the degassing stream as a feedstock stream into the stage for steam-cracking, the degassing stream is subjected to a scrubbing step suitable for removing catalyst poisons, catalyst residues or other undesirable substances.

8. A process according to claim 1, further comprising passing said tail gas, as a fuel, to a unit for combusting said fuel gas.
